(19) United States
(12) Patent Application Publication
(10) Pub. No.: US 2023/0231340 A1
(43) Pub. Date: Jul. 20, 2023

(54) WIRE COVER AND CONNECTOR STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki KOBAYASHI, Mie (JP); Shunya TAKEUCHI, Mie (JP); Teruo HARA, Mie (JP); Hajime MATSUI, Mie (JP); Nungna WI, Mie (JP); Masaaki TABATA, Mie (JP)

(21) Appl. No.: 18/010,326

(22) PCT Filed: May 27, 2021
(86) PCT No.: PCT/JP2021/020224

§ 371 Date: Dec. 14, 2022

(30) Foreign Application Priority Data
Jun. 17, 2020 (JP) 2020-104410

(51) Int. Cl. H01R 13/58

(52) U.S. Cl. CPC H01R 13/5841

(57) ABSTRACT

A wire cover is to be mounted on a rear side in a connecting direction of a connector to be connected to a mating connector. The connector includes a plurality of female terminals disposed apart from each other in a lateral direction and a plurality of wires connected to the respective female terminals and pulled out from the rear side in the connecting direction. The wire cover includes a housing having an insertion opening through which the plurality of wires are inserted and a draw-out opening through which the plurality of wires inserted through the insertion opening are drawn out rightward, and an assisting member for assisting three-dimensional bending of the respective wires inside the housing. The respective wires are three-dimensionally bent inside the housing and drawn out through the draw-out opening by being assisted by the assisting member.

### TECHNICAL FIELD

A technique disclosed in this specification relates to a wire cover and a connector structure.

### BACKGROUND

Conventionally, a wire cover is known which is mounted on a rear side in a connecting direction of a connector and from which a plurality of wires pulled out rearward in the connecting direction from the connector and bent in a direction intersecting the connecting direction are pulled out (see, for example, Patent Document 1). Specifically, a laterally extended connector cover described in Patent Document 1 is mounted on a rear side in a connecting direction of a waterproof laterally extended connector and a plurality of wires are curved inside the cover and laterally pulled out through a wire pull-out opening as shown in FIG. 6 of Patent Document 1.

The cover described in Patent Document 1 above is composed of a body cover and a lid cover, and guide ribs for securing straight parts of the wires project on the inner surface of the body cover. In this cover, the wires are routed along the guide ribs and laterally bent after the straight parts are secured, thereby preventing waterproof rubber plugs from being deformed to cause water intrusion into the connector.

### PRIOR ART DOCUMENT

### Patent Document

Patent Document 1: JP 2012-234659 A

### SUMMARY OF THE INVENTION

### Problems to Be Solved

If a wire pulled out from a wire cover is strongly pulled, the wire may come out from a terminal of a connector. In the cover described in Patent Document 1 above, this point was not sufficiently studied.

In this specification, a technique is disclosed which makes a wire less likely to come out from a terminal by a compact configuration even if a force is generated in a direction to pull out the wire from the terminal in a wire cover for pulling out a plurality of wires pulled out from a connector in a direction intersecting a connecting direction.

### Means to Solve the Problem

A wire cover of the present disclosure is a wire cover to be mounted on a rear side in a connecting direction of a connector to be connected to a mating connector, wherein the connector includes a plurality of terminals disposed apart from each other in a first orthogonal direction orthogonal to the connecting direction and a plurality of wires connected to the respective terminals and pulled out from the rear side in the connecting direction, the wire cover includes a housing having an insertion opening, the plurality of wires being inserted through the insertion opening, and a draw-out opening, the plurality of wires inserted through the insertion opening being drawn out through the draw-out opening in a direction intersecting the connecting direction, and an assisting member for assisting three-dimensional bending of the respective wires inside the housing, and the respective wires are three-dimensionally bent inside the housing and drawn out through the draw-out opening by being assisted by the assisting member.

### Effect of the Invention

According to the wire cover of the present disclosure, the wire can be made less likely to come out from the terminal by a compact configuration even if a force is generated in a direction to pull out the wire from the terminal in a wire cover for pulling out a plurality of wires pulled out from a connector in a direction intersecting a connecting direction.

### BRIEF DESCRIPTION OF THE DRAWINGS

FIG. 1 is a perspective view of a connector structure according to a first embodiment.

FIG. 2 is a perspective view of the connector structure.

FIG. 3 is a perspective view of a connector.

FIG. 4 is a perspective view of the connector.

FIG. 5 is a section of the connector.

FIG. 6 is a disassembled perspective view of a wire cover.

FIG. 7 is a disassembled perspective view of the connector structure.

FIG. 8 is a disassembled perspective view of the connector structure.

FIG. 9 is a disassembled top view of the connector structure.

FIG. 10 is a perspective view of a connector structure according to a second embodiment.

FIG. 11 is a section of the connector structure.

FIG. 12 is a disassembled perspective view of a wire cover according to a third embodiment.

FIG. 13 is a disassembled top view of a wire cover according to another embodiment.

FIG. 14 is a disassembled top view of a wire cover according to another embodiment.

FIG. 15 is a disassembled top view of a wire cover according to another embodiment.

FIG. 16 is a disassembled top view of a wire cover according to another embodiment.

### DETAILED DESCRIPTION TO EXECUTE THE INVENTION

### Description of Embodiments of Present Disclosure

First, embodiments of the present disclosure are listed and described.

(1) The wire cover of the present disclosure is a wire cover to be mounted on a rear side in a connecting direction of a connector to be connected to a mating connector, wherein the connector includes a plurality of terminals disposed apart from each other in a first orthogonal direction orthogonal to the connecting direction and a plurality of wires connected to the respective terminals and pulled out from the rear side in the connecting direction, the wire cover includes a housing having an insertion opening, the plurality of wires being inserted through the insertion opening, and a draw-out opening, the plurality of wires inserted through the insertion opening being drawn out through the draw-out opening in a direction intersecting the connecting direction, and an assisting member for assisting three-dimensional bending of the respective wires inside the housing, and the respective wires are three-dimensionally bent inside the housing and drawn out through the draw-out opening by being assisted by the assisting member.

In the cover described in Patent Document 1 above, the respective wires are differently bent inside the cover. Since a larger force acts on the wire more outside a bend when the wire is pulled in the cover described in Patent Document 1, the wire outside the bend easily comes out from the terminal.

According to the configuration of the present disclosure, since the bending of each of the wires is assisted inside the wire cover by the assisting member, the respective wires can be uniformly bent. Thus, a force acting on each wire when the wire is pulled is made uniform and it can be suppressed that a large force acts on the wire outside the bend.

To pull out the respective wires in the direction intersecting the connecting direction while uniformly bending the wires, it is also possible to planarly bend the respective wires only once inside the wire cover by assisting the wires by the assisting member. However, in that case, friction is generated only at one position between the wires and the assisting member. In contrast, in the wire cover according to the invention, the respective wires are three-dimensionally bent by being assisted by the assisting member. Since the wires are bent two or more times if being three-dimensionally bent, friction is generated at more positions between the wires and the assisting member as compared to the case of bending only once. Thus, a force for pulling out the wire from the terminal of the connector can be reduced. Further, if the wires are three-dimensionally bent, it can be realized by a compact configuration as compared to the case of planar bending two or more times that the wires are pulled out in the direction intersecting the connecting direction while positions where friction is generated between the wires and the assisting member are increased.

Thus, according to the configuration of the present disclosure, it can be realized by a compact configuration to make the wire less likely to come out from the terminal even if a force is generated in a direction to pull out the wire from the terminal in the wire cover for pulling out the plurality of wires pulled out from the connector in the direction intersecting the connecting direction.

(2) Preferably, the housing includes a first cover disposed on one side in a second orthogonal direction orthogonal to both the connecting direction and the first orthogonal direction with respect to the plurality of wires and a second cover facing the first cover across the plurality of wires, the assisting member is a plate-like member to be disposed between the second cover and the wires, and the respective wires extending rearward in the connecting direction by being inserted through the insertion opening are bent toward the second cover by being assisted by the assisting member at a position where the wires pass through the assisting member, and the respective wires bent toward the second cover are bent toward the draw-out opening by being assisted by the assisting member.

According to the above configuration, friction is generated between the wires and the assisting member at a position where the wires are bent toward the second cover and friction is generated between the wires and the assisting member at a position where the respective wires bent toward the second cover are bent toward the draw-out opening. That is, according to the above wire cover, friction is generated at two positions between the wires and assisting member by three-dimensionally bending the wires. Thus, a force for pulling out the wire from the terminal can be reduced as compared to the case of planarly bending the wires only once.

(3) Preferably, an edge part on a rear side in the connecting direction of the assisting member is inclined toward the rear side in the connecting direction from one side toward the other side in the first orthogonal direction.

According to the above configuration, since the edge part on the rear side in the connecting direction of the assisting member is inclined, the wires can be pulled out at a right angle or an angle close to a right angle with respect to the connecting direction while being three-dimensionally bent.

(4) Preferably, one or a plurality of recesses are formed in the edge part of the assisting member, and the respective wires bent toward the second cover by being assisted by the assisting member at the position where the wires pass through the assisting member pass through the recess(es).

According to the above configuration, since the positions of the wires are restricted by the recess(es), movements of the wires in the housing can be suppressed.

(5) Preferably, the recess is formed for each wire.

According to the above configuration, since the recess is formed for each wire, movements of the wires in the housing can be more reliably suppressed, for example, as compared to the case where one recess is provided for a plurality of wires such as one for two wires or one for three wires.

(6) Preferably, the recess has a triangular shape when viewed from the second orthogonal direction.

According to the above configuration, the wire is bent with one of two sides constituting the right triangular shape as a support point and, after the wire bent with the one side as the support point passes through the recess, the wire is bent with the other side as a support point, whereby the wire is more easily pulled out at a right angle or an angle close to a right angle with respect to the connecting direction.

Preferably, the assisting member is coupled to the housing by a hinge.

According to the above configuration, since the assisting member is coupled to the housing by the hinge, the efficiency of an operation of mounting the wire cover is improved as compared to the case where the assisting member and the housing are not coupled.

(8) Preferably, a restricting portion is provided which is disposed on the rear side in the connecting direction with respect to the assisting member, the restricting portion restricting movements of the wires in the housing in cooperation with the assisting member.

According to the above configuration, the assisting member and the restricting portion restrict movements of the wires in cooperation, whereby movements of the wires in the housing can be more reliably suppressed.

(9) A connector structure of the present disclosure is provided with a connector to be connected to a mating connector, the connector including a plurality of terminals disposed apart from each other in a first orthogonal direction orthogonal to a connecting direction and a plurality of wires connected to the respective terminals and pulled out from a rear side in the connecting direction, and the wire cover of any one of claims 1 to 8 to be mounted on the rear side in the connecting direction of the connector.

According to the above configuration, in the connector structure provided with the wire cover for pulling out the plurality of wires pulled out from the connector in the direction intersecting the connecting direction, it can be realized by a compact configuration to make the wire less likely to come out from the terminal even if a force is generated in a direction to pull out the wire from the terminal.

### Details of Embodiments of Present Disclosure

Hereinafter, embodiments of the present disclosure are described. Note that the present disclosure is not limited to these illustrations, but is represented by claims, and is intended to include all changes in the scope of claims and in the meaning and scope of equivalents.

### First Embodiment

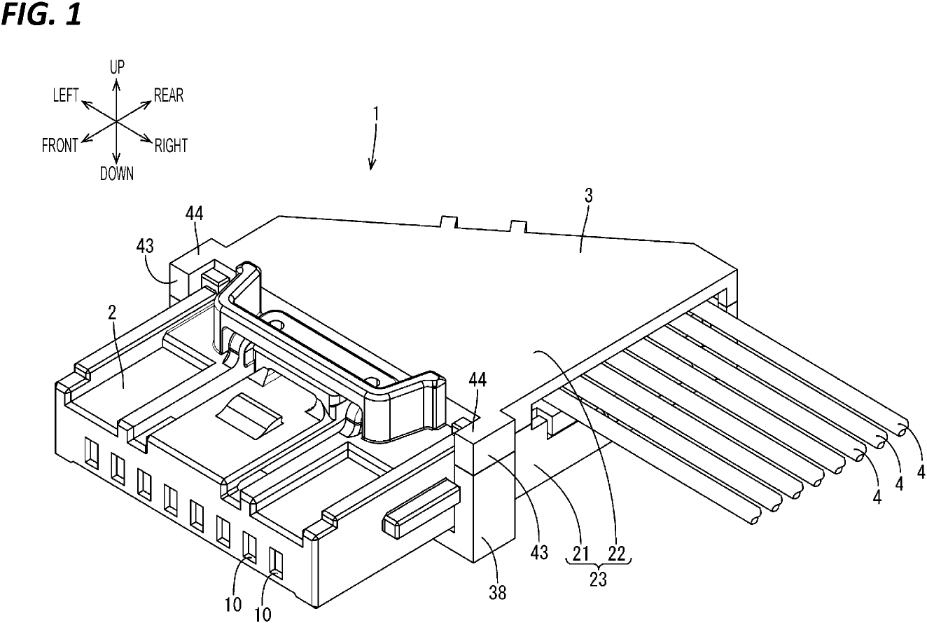

A first embodiment is described with reference to FIGS. 1 to 9. In the following description, a front-rear direction, a lateral direction and a vertical direction are based on a front-rear direction, a lateral direction and a vertical direction in FIG. 1. The front-rear direction is an example of a connecting direction. The lateral direction is an example of a first orthogonal direction orthogonal to the connecting direction. The vertical direction is an example of a second orthogonal direction orthogonal to both the connecting direction and the first orthogonal direction. For a plurality of identical members, some members may be denoted by a reference sign, but the other members may not be denoted by the reference sign.

### Connector Structure

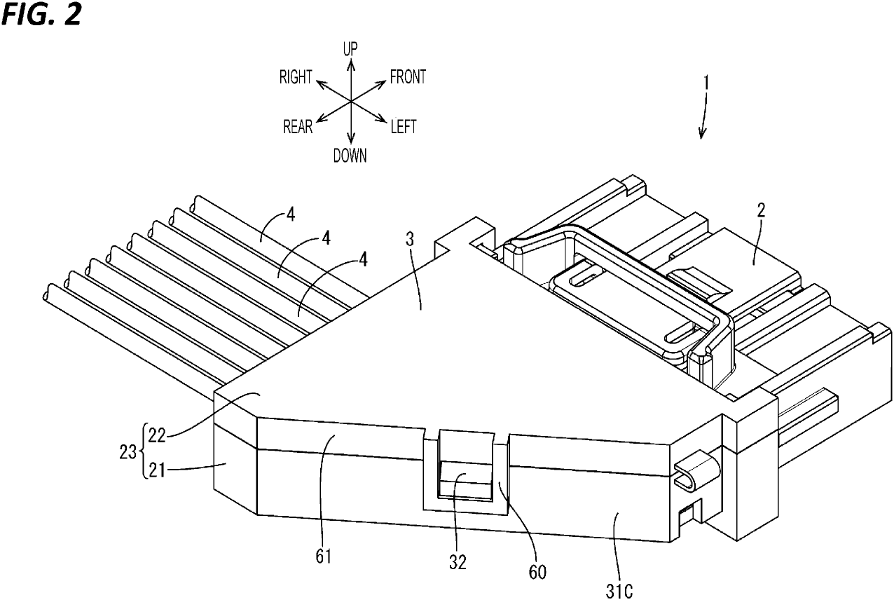

As shown in FIGS. 1 and 2, a connector structure 1 according to the first embodiment includes a connector 2 to be connected to an unillustrated mating connector and a wire cover 3 to be mounted on a rear side of the connector 2.

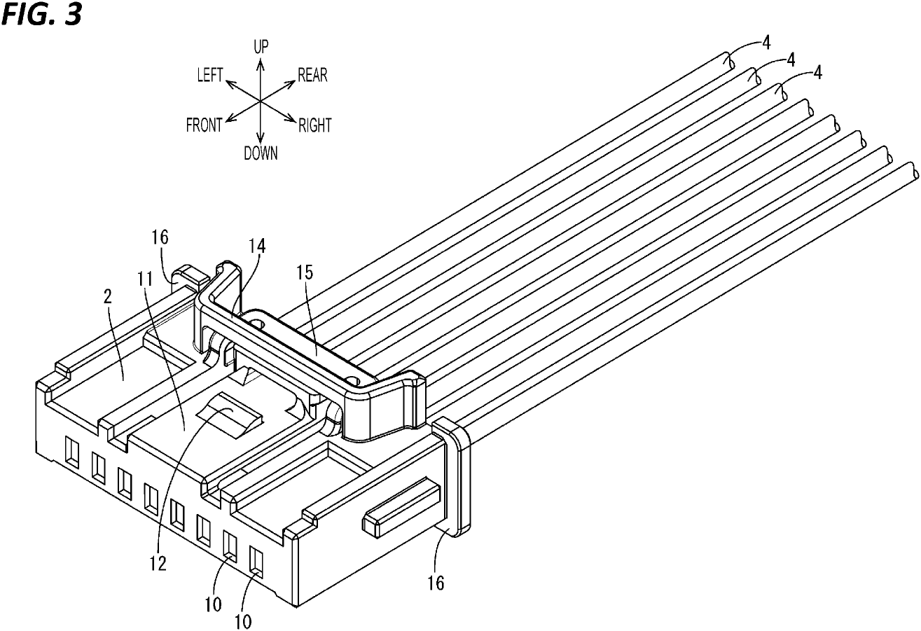

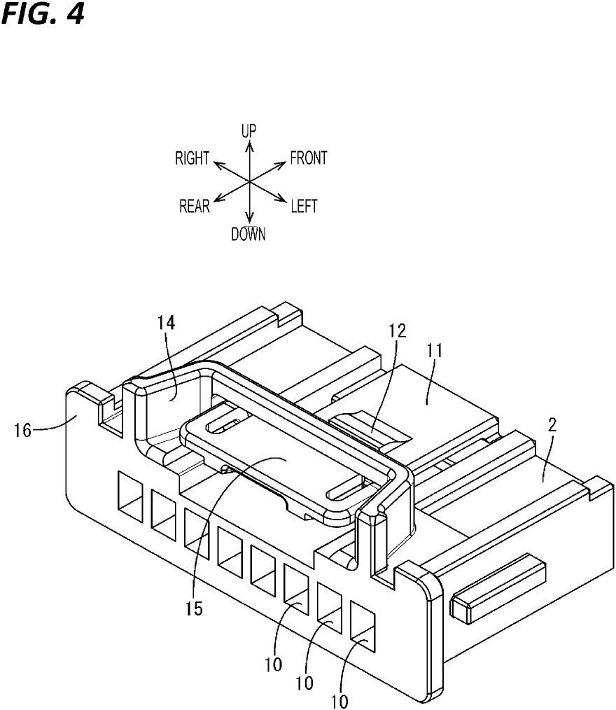

As shown in FIGS. 3 and 4, the connector 2 is made of insulating synthetic resin and has a substantially rectangular parallelepiped shape flat in the vertical direction. The connector 2 is formed with a plurality of cavities 10 extending in the front-rear direction. The plurality of cavities 10 are arranged at intervals in the lateral direction. The cavities 10 are open forward and rearward.

A resiliently deformable lock arm 11 is formed to extend rearward from a front end part of the connector 2 on the upper surface of the connector 2. A lock portion 12 to be engaged into an engaging hole of the mating connector is formed to project upward on the upper surface of the lock arm 11. A grip portion 15 in the form of a plate extending in the lateral direction is provided in a rear end part of the lock arm 11. A worker can resiliently deform the lock arm 11 by placing fingers on the grip portion 15.

A protection rib 14 projecting upward is formed on the upper surface of the connector 2. A projecting height of the protection rib 14 from the connector 2 is set larger than that of the lock arm 11 from the upper surface of the connector 2.

An end rib 16 projecting in the vertical direction and lateral direction are provided on a rear end part of the connector 2. The end rib 16 is provided on both left and right end parts of the connector 2 on the upper surface of the connector 2. The end rib 16 is provided in entire regions in the vertical direction on both left and right side surfaces of the connector 2. The end rib 16 is provided in an entire region in the lateral direction on the lower surface of the connector 2.

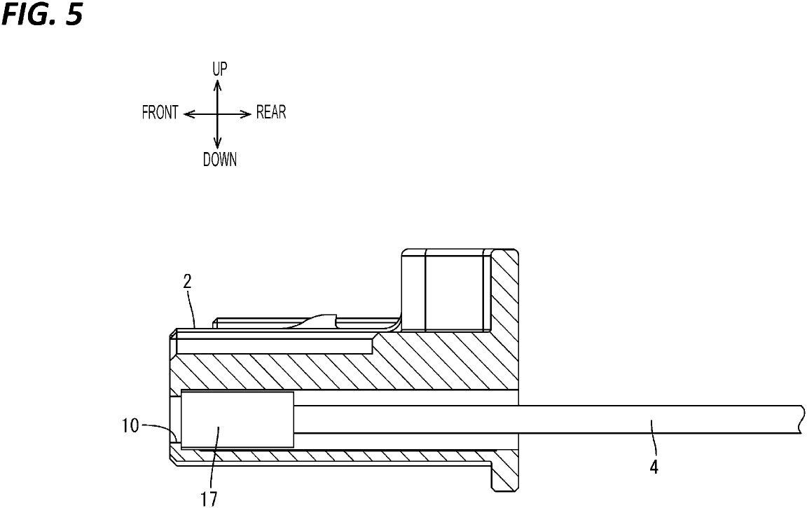

As shown in FIG. 5, a female terminal 17 (an example of a terminal) made of metal is accommodated inside each cavity 10. The female terminal 17 is in the form of a rectangular tube extending in the front-rear direction. A wire 4 is connected to a rear end part of the female terminal 17. The wire 4 is such that the outer peripheral surface of a core wire is surrounded with an insulation coating made of insulating synthetic resin. The insulation coating is stripped in an end part of the wire 4 to expose the core wire. The core wire according to the first embodiment is a so-called single core wire constituted by one metal wire. The core wire may be a stranded wire obtained by stranding a plurality of thin metal wires. The wire 4 is connected to the female terminal 17 by crimping, welding, soldering or the like and extends rearward from the female terminal 17.

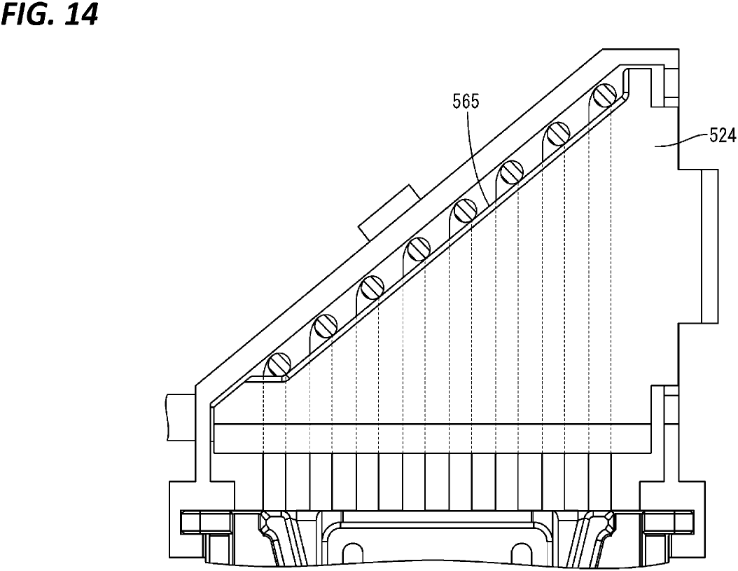

Although not shown in FIG. 5, a restricting portion for preventing the female terminal 17 from coming out rearward is provided behind the female terminal 17 inside the cavity 10. Thus, the female terminal 17 does not move rearward from a position shown in FIG. 14 even if the wire 4 is pulled rearward.

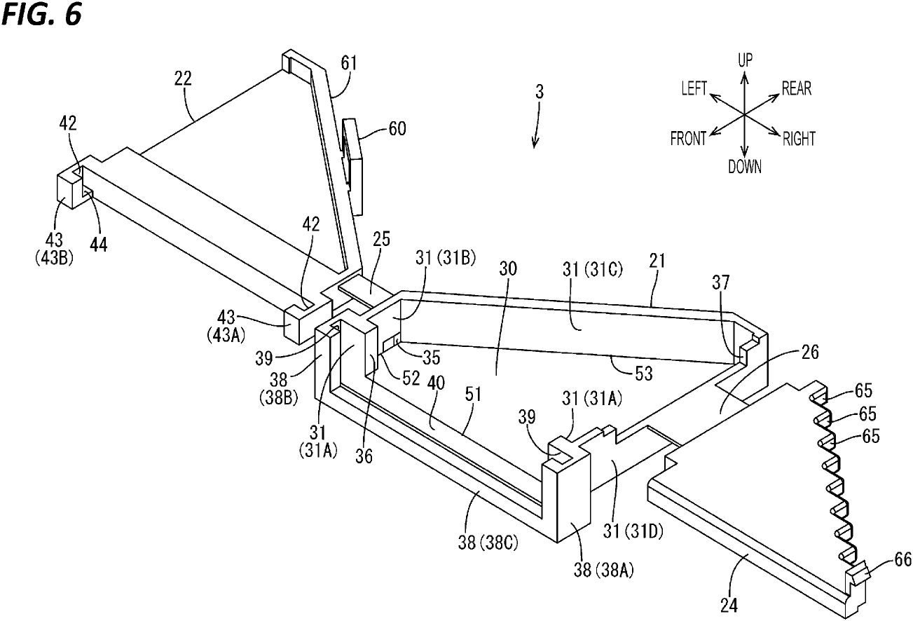

As shown in FIG. 1, the wire cover 3 is for bending a plurality of the wires 4 pulled out rearward from the connector 2 rightward (an example of a direction intersecting the connecting direction) at 90°. The wire cover 3 includes a first cover 21 and a second cover 22 shown in FIG. 1 and an assisting member 24 shown in FIG. 6.

As shown in FIG. 1, the first and second covers 21, 22 constitute a housing 23 of the wire cover 3.

As shown in FIG. 6, the first cover 21 includes a bottom wall portion 30 and four side wall portions 31 (31A, 31B, 31C and 31D) rising from an outer peripheral edge part of the bottom wall portion 30. In a plan view, the bottom wall portion 30 has a rectangular shape having four sides including a bottom side 51, a left side 52, a right side (not shown) and an upper side 53, and the right side is longer than the left side 52. Thus, the upper side 53 is inclined to be more separated from the bottom side 51 from the left end to the right end of the bottom side 51. Specifically, the upper side 53 is inclined at an angle of 45° with respect to the bottom side 51. 45° is an example. An angle of the upper side 53 can be appropriately determined. In the following description, the upper side 53 is referred to as an oblique side 53.

The side wall portion 31C (an example of a restricting portion) rising along the oblique side 53 of the bottom wall portion 30 restricts movements of the wires 4 in the front-rear direction in the housing 23 in cooperation with the assisting member 24 to be described later. As shown in FIG. 2, a locking projection 32 to be locked to a lock arm 60 formed on the second cover 22 is formed on the outer surface of the side wall portion 3C.

As shown in FIG. 6, a rectangular cut is formed in a middle part of the side wall portion 31A rising along the bottom side 51 of the bottom wall portion 30. A width in the lateral direction of a rectangularly cut part is larger than a width in the lateral direction of the plurality of wires 4 arranged in the lateral direction, and constitutes an insertion opening 36 through which the plurality of wires 4 are inserted into the housing 23.

A rectangular cut is formed in a middle part of the side wall portion 31D rising along the right side of the bottom wall portion 30. A width in the front-rear direction of a cut part is larger than a width in the front-rear direction of the plurality of wires 4 bent at 90° and extending rightward, and constitutes a draw-out opening 37 through which the plurality of wires 4 inserted through the insertion opening 36 are drawn out rightward.

The side wall portion 31B rising along the left side 52 of the bottom wall portion 30 is formed with a locking hole 35, into which a locked portion 66 provided on the assisting member 24 to be described later is locked.

A first guide portion 38 including a groove, into which the end rib 16 of the connector 2 is inserted from above, is integrally provided on a front side of the first cover 21. Specifically, the first guide portion 38 includes a right wall portion 38A protruding forward from the outer surface of the side wall portion 31D, a left wall portion 38B protruding forward from the outer surface of the side wall portion 31B and a lower wall portion 38C protruding forward from the lower surface of the bottom wall portion 30.

A vertical groove 39 extending in the vertical direction is formed in a leftward facing surface of the right wall portion 38A. A vertical groove 39 extending in the vertical direction is formed in a rightward facing surface of the left wall portion 38B. A horizontal groove 40 extending in the lateral direction is formed in an upward facing surface of the lower wall portion 38C. Widths in the front-rear direction of these grooves 39, 40 substantially match the width in the front-rear direction of the end rib 16.

As shown in FIG. 1, the second cover 22 is disposed above the plurality of wires 4 and facing the first cover 21 across the plurality of wires 4. In a plan view, the outer peripheral shape of the second cover 22 substantially matches that of the first cover 21.

As shown in FIG. 6, the second cover 22 is substantially in the form of a flat plate. The second cover 22 is rotatably coupled to the first cover 21 by a hinge 25. A second guide portion 43 including a groove 42, into which an upper end part of the end rib 16 of the connector 2 is inserted, is integrally provided on a front side of the second cover 22. Specifically, the second guide portion 43 includes a right guide portion 43A protruding forward from the right end surface of the second cover 22 and a left guide portion 43B protruding forward from the left end surface of the second cover 22. A vertical groove 42 extending in the vertical direction is formed in a leftward facing surface of the right guide portion 43A. A vertical groove 42 extending in the vertical direction is formed in a rightward facing surface of the left guide portion 43B. Widths in the front-rear direction of these grooves 42 substantially match that of the end rib 16. Walls 44 for preventing the end rib 16 from facing upward are formed on lower sides of these vertical grooves 42.

As shown in FIGS. 2 and 6, the resiliently deformable lock arm 60 to be locked to the locking projection 32 formed on the outer surface of the side wall portion 31C is formed on a rear side of the second cover 22.

With reference to FIG. 6, the assisting member 24 is described. The assisting member 24 assists three-dimensional bending of the respective wires 4 inside the housing 23. The assisting member 24 is a plate-like member disposed between the second cover 22 and the wires 4, and rotatably coupled to the side wall portion 31D of the first cover 21 by a hinge 26. The outer peripheral shape of the assisting member 24 substantially matches the shape of an internal space of the housing 23 when viewed from above, but a width in the front-rear direction of the assisting member 24 is smaller than that of the internal space of the housing 23.

With the assisting member 24 rotated and accommodated inside the housing 23, an edge part on a rear side in the connecting direction of the assisting member 24 is inclined rearward from a left side (an example of one side in a first orthogonal direction) toward a right side (an example of the other side) in the lateral direction.

A plurality of recesses 65 are formed in the edge part on the rear side in the connecting direction of the assisting member 24. The number of the recesses 65 is equal to that of the wires 4. Each recess 65 is formed into a right triangle shape in a plan view. By successively forming the plurality of recesses 65 having a right triangle shape, the edge part on the rear side in the connecting direction of the assisting member 24 is formed stepwise.

The resiliently deformable locked portion 66 projecting upward is integrally provided on a right end part of the assisting member 24. The locked portion 66 includes an arm portion extending upward and a locking claw protruding rightward from a tip part of the arm portion. If the assisting member 24 is closed, the locking claw is locked into the locking hole 35 formed in the side wall portion 31B of the first cover 21, whereby the assisting member 24 is locked to the first cover 21.

### Mounting of Wire Cover

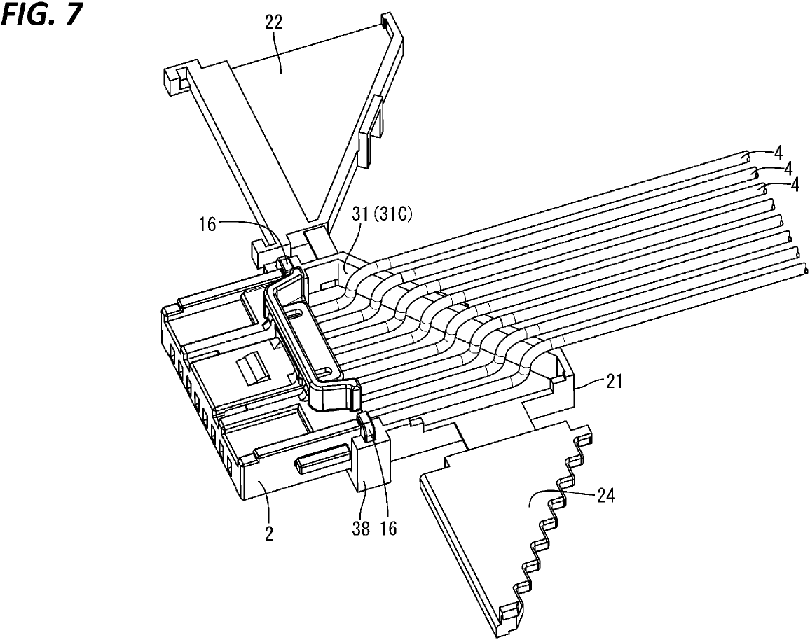

As shown in FIG. 7, in mounting the wire cover 3 on the connector 2, the end rib 16 of the connector 2 is first inserted into the grooves 39, 40 of the first guide portion 38 of the wire cover 3, whereby the wire cover 3 is mounted on the connector 2. If the wire cover 3 is mounted on the connector 2, the wires 4 pulled out from the rear side of the connector 2 extend rearward along the upper surface of the first cover 21, ride over the side wall portion 31C of the first cover 21 and extend further rearward.

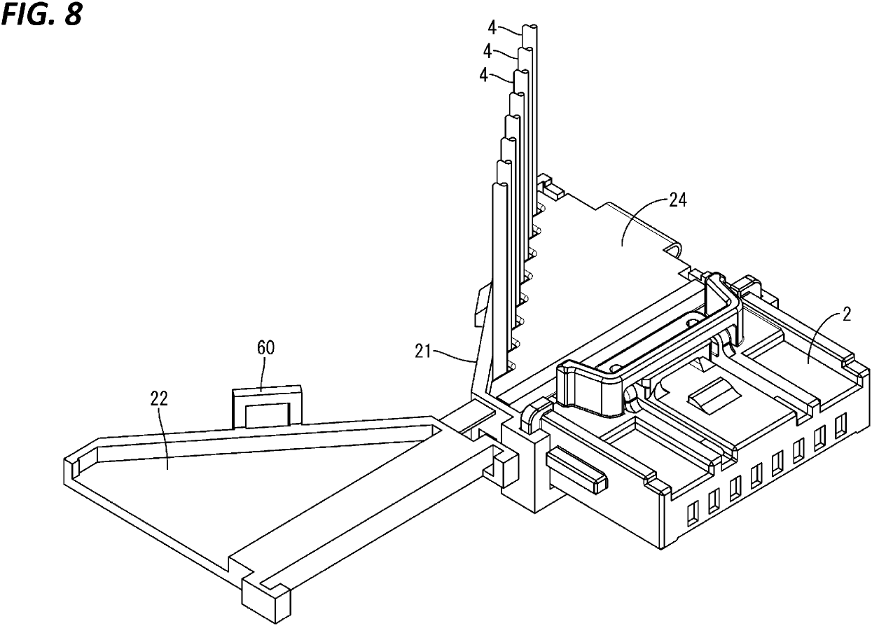

Subsequently, as shown in FIG. 8, the respective wires 4 are bent at 90° at a position where the wires 4 butt against the inner surface (oblique surface) of the side wall portion 31C and, in that state, the assisting member 24 is closed. In this way, the respective wires 4 inserted through the insertion opening 36 and extending rearward in the connecting direction are bent upward (toward the second cover 22) by being assisted by the assisting member 24 at a position where the wires 4 are passed through the assisting member 24. Then, the wires 4 bent upward pass through the recesses 65 and extend upward.

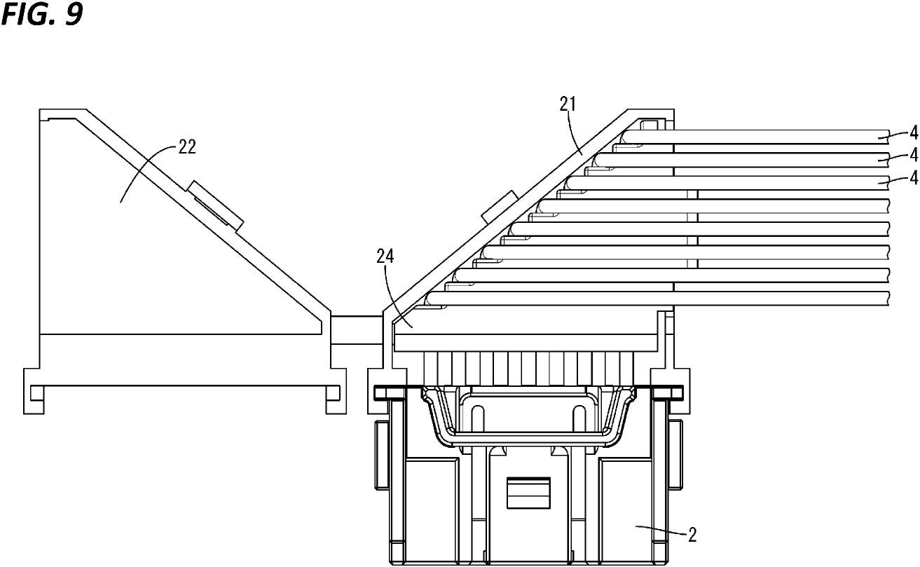

Subsequently, as shown in FIG. 9, the respective wires 4 passed through the recesses 65 are bent rightward (an example of the side of the draw-out opening 37) at 90° and pulled out to outside through the draw-out opening 37 by being assisted by the assisting member 24.

Subsequently, as shown in FIGS. 1 and 2, the second cover 22 is closed with the respective wires 4 pulled out from the draw-out opening 37. If the second cover 22 is closed, the lock arm 60 of the second cover 22 is locked to the locking projection 32, whereby the first and second covers 21, 22 are locked.

### Effects of Embodiment

According to the wire cover 3 of the first embodiment, since the bending of the respective wires 4 is assisted by the assisting member 24 inside the wire cover 3, the respective wires 4 can be uniformly bent. Thus, a force acting on each wire 4 when the wire 4 is pulled is made uniform and it can be suppressed that a large force acts on the wire 4 outside a bend.

Further, the wire cover 3 three-dimensionally bends the respective wires 4 by being assisted by the assisting member 24. If the wires 4 are three-dimensionally bent, the wires 4 are bent two or more times. Thus, parts where resistance is generated between the wires 4 and the assisting member 24 are increased as compared to the case where the wires 4 are bent only once. Thus, a force for pulling out the wire 4 from the female terminal 17 of the connector 2 can be reduced. Further, if the wires 4 are three-dimensionally bent, it can be realized by a more compact configuration that the wires 4 are pulled out in the direction intersecting the connecting direction while parts where friction is generated between the wires 4 and the assisting member 24 are increased.

Therefore, according to the configuration of the first embodiment, it can be realized by a compact configuration to make the wire 4 less likely to come out from the female terminal 17 even if a force is generated in a direction to pull out the wire 4 from the female terminal 17 in the wire cover 3 for pulling out the plurality of wires 4 pulled out from the connector 2 in the direction intersecting the connecting direction.

According to the wire cover 3, friction is generated between the wires 4 and the assisting member 24 at the position where the wires 4 are bent toward the second cover 22 (position where the wires 4 are bent upward) and friction is generated between the wires 4 and the assisting member 24 at the position where the respective wires 4 bent toward the second cover 22 are bent toward the draw-out opening 37 (position where the wires 4 are bent rightward). That is, according to the wire cover 3, friction is generated at two positions between the wires 4 and the assisting member 24 by three-dimensionally bending the wires 4. Thus, a force for pulling out the wire 4 from the female terminal 17 can be reduced as compared to the case where the wire 4 is planarly bent only once.

Since the edge part on the rear side in the connecting direction of the assisting member 24 is inclined according to the wire cover 3, the wires 4 can be pulled out at a right angle or an angle close to a right angle with respect to the connecting direction while being three-dimensionally bent.

Since the positions of the wires 4 are restricted by the recesses 65 according to the wire cover 3, movements of the wires 4 in the housing 23 can be suppressed.

Since the recess 65 is formed for each wire 4 according to the wire cover 3, movements of the wires 4 in the housing 23 can be more reliably suppressed, for example, as compared to the case where one recess is provided for a plurality of wires 4 such as one for two wires 4 or one for three wires 4.

Since the recess 65 has a right triangle shape when viewed from the vertical direction (second orthogonal direction) according to the wire cover 3, the wire 4 is bent with one of two sides constituting a right angle of the right triangle shape as a support point and, after the wire 4 bent with the one side as the support point passes through the recess, the wire 4 is bent with the other side as a support point, whereby the wire 4 is more easily pulled out at a right angle or an angle close to a right angle with respect to the connecting direction.

Since the assisting member 24 is coupled to the housing 23 by the hinge 26 according to the wire cover 3, the efficiency of an operation of mounting the wire cover 3 is improved as compared to the case where the assisting member 24 and the housing 23 are not coupled.

According to the wire cover 3, the assisting member 24 and the side wall portion 31C (restricting portion) restrict movements of the wires 4 in the front-rear direction in cooperation, whereby movements of the wires 4 in the housing 23 can be more reliably suppressed.

According to the connector 2 of the first embodiment, in the connector structure 1 provided with the wire cover 3 for pulling out the plurality of wires 4 pulled out from the connector 2 in the direction intersecting the connecting direction, a possibility that the wire 4 comes out from the female terminal 17 of the connector 2 when being pulled can be reduced by a compact configuration.

### Second Embodiment

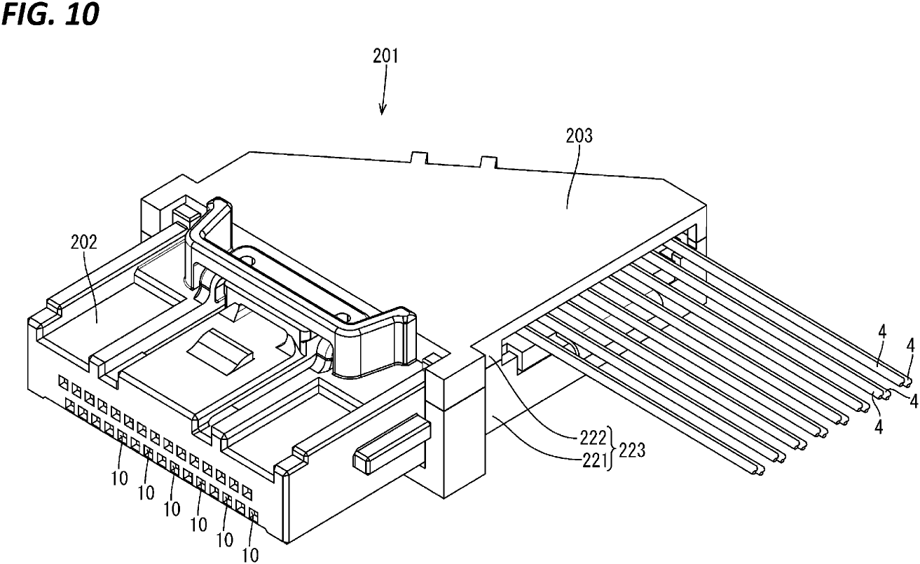

As shown in FIG. 10, a connector structure 201 according to a second embodiment is provided with a connector 202 and a wire cover 203. The connector 202 is provided with a plurality of cavities 10 separated in two upper and lower stages. The cavities 10 in the upper stage are disposed in a row while being separated in the lateral direction. The cavities 10 in the lower stage are also disposed in a row while being separated in the lateral direction.

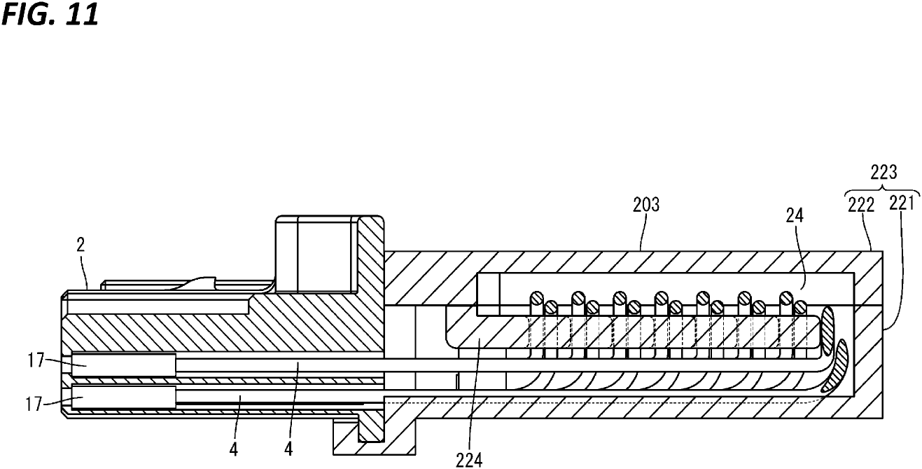

The inside of the wire cover 203 is described with reference to FIG. 11. Although wires 4 are pulled out in two upper and lower stages from a rear side of the connector 202 in the second embodiment, those wires 4 are not vertically partitioned inside the wire cover 203 and both the wires 4 in the upper stage and the wires 4 in the lower stage extend rearward between a first cover 221 and an assisting member 224.

The connector structure 201 according to the second embodiment is substantially the same as in the first embodiment in other points.

### Third Embodiment

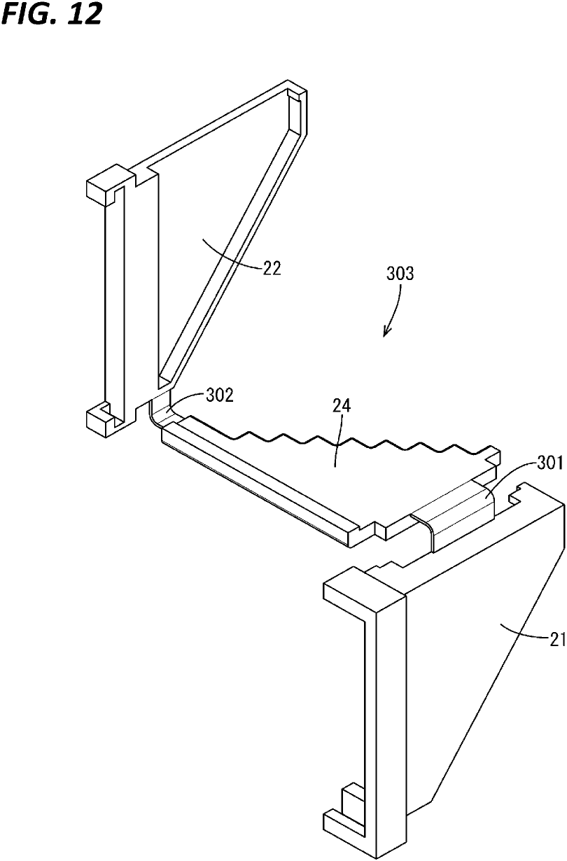

As shown in FIG. 12, a first cover 21 and a second cover 22 are coupled via an assisting member 24 in a wire cover 303 according to a third embodiment. Specifically, the first cover 21 is coupled to the assisting member 24 via a hinge 301. The second cover 22 is coupled to the assisting member 24 via a hinge 302. The third embodiment is substantially the same as in the first embodiment in other points.

### Other Embodiments

The technique disclosed by this specification is not limited to the above described and illustrated embodiments. For example, the following embodiments are also included in a technical scope disclosed by this specification.

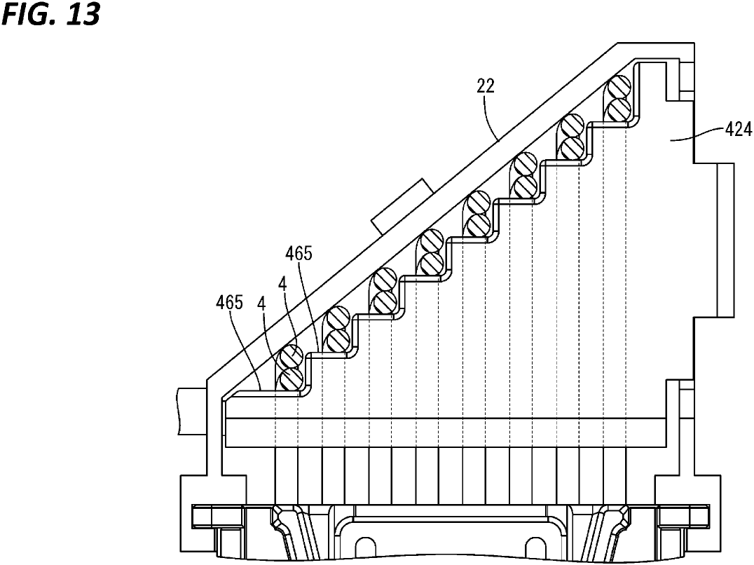

(1) One recess 65 is provided for each wire 4 in the assisting member 24 of the above first embodiment. In contrast, one recess 465 may be provided for a plurality of (two in FIG. 13) wires 4 as in an assisting member 424 shown in FIG. 13, and the plurality of wires 4 may pass through the same recess 465.

(2) The assisting member 24 of the above first embodiment includes the recesses 65. In contrast, only one recess 565 may be provided as in an assisting member 524 shown in FIG. 14. Alternatively, the assisting member 24 may include no recess.

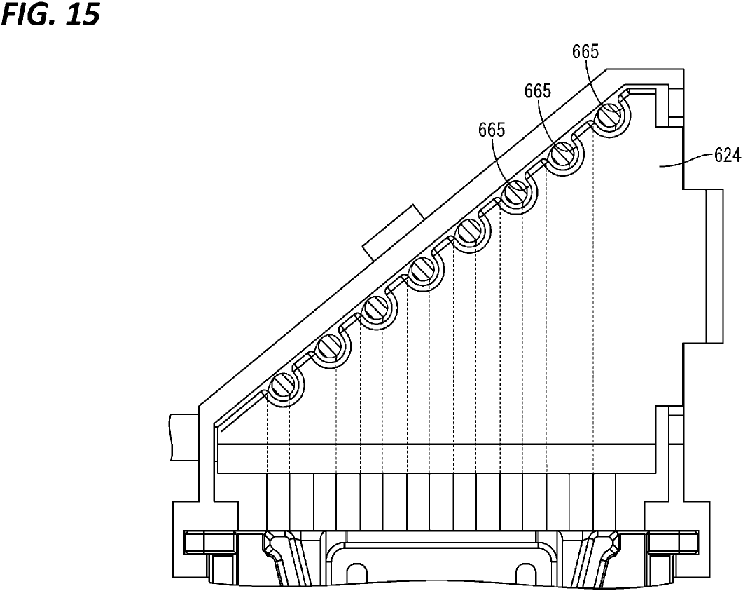

(3) The recesses of the assisting member 24 of the above first embodiment have a right triangle shape. In contrast, the recesses may be formed into a semicircular shape like recesses 665 shown in FIG. 15.

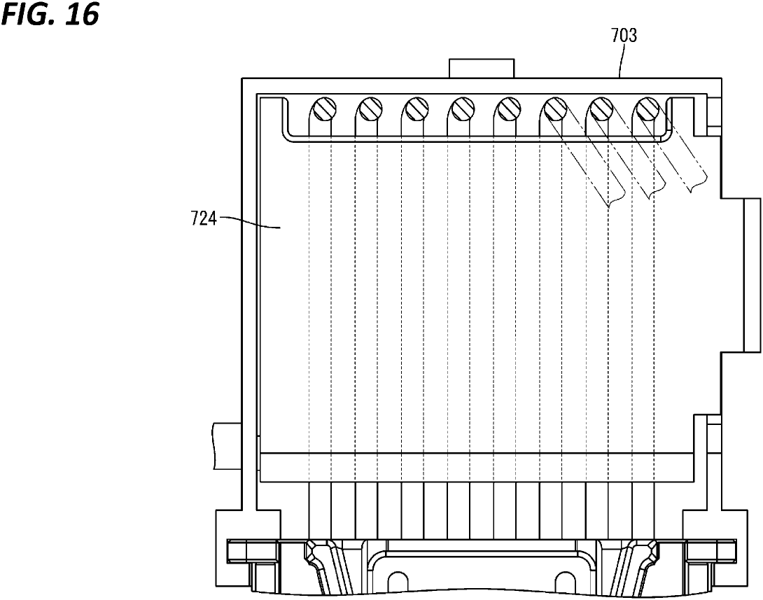

(4) The wire cover 3 of the above first embodiment has the oblique side 53. In contrast, a wire cover may not have the oblique side 53 like a wire cover 703 shown in FIG. 16. In this case, an assisting member 724 is also shaped not to have an oblique side in conformity with the shape of the wire cover 703.

(5) Although the assisting member 24 and the wire cover are integrally formed in the above first embodiment, the assisting member 24 may be integrally formed to the connector 2 and extend rearward in the connecting direction from the connector 2. The assisting member 24 extending rearward may be inserted into the housing 23 of the wire cover 3 to assist three-dimensional bending of the wires 4.

(6) Although the recess 65 has a right triangle shape when viewed from the vertical direction (second orthogonal direction) in the above first embodiment, the recess 65 may have a triangular shape other than a right triangle shape.

List of Reference Numerals

| | |
|---|---|
| 1: | connector structure |
| 2: | connector |
| 3: | wire cover |
| 4: | wire |
| 10: | cavity |
| 11: | lock arm |
| 12: | lock portion |
| 14: | protection rib |
| 15: | grip portion |
| 16: | end rib |
| 17: | female terminal (example of terminal) |
| 21: | first cover |
| 22: | second cover |
| 23: | housing |
| 24: | assisting member |
| 25: | hinge |
| 26: | hinge |
| 30: | bottom wall portion |
| 31: | side wall portion |
| 31A: | side wall portion |
| 31B: | side wall portion |
| 31C: | side wall portion (example of restricting portion) |
| 31D: | side wall portion |
| 32: | locking projection |
| 35: | locking hole |
| 36: | insertion opening |
| 37: | draw-out opening |
| 38: | guide portion |
| 38A: | right wall portion |
| 38B: | left wall portion |
| 38C: | lower wall portion |
| 39: | vertical groove |
| 40: | horizontal groove |
| 42: | vertical groove |
| 43: | guide portion |
| 43A: | right guide portion |
| 43B: | left guide portion |
| 44: | wall |
| 51: | bottom side |
| 52: | left side |
| 53: | upper side |
| 60: | lock arm |
| 65: | recess |
| 66: | locked portion |
| 201: | connector structure |
| 202: | connector |
| 203: | wire cover |
| 221: | first cover |
| 224: | assisting member |
| 301: | hinge |
| 302: | hinge |
| 303: | wire cover |
| 424: | assisting member |
| 465: | recess |
| 524: | assisting member |
| 565: | recess |
| 665: | recess |
| 702: | wire cover |
| 724: | assisting member |

1. A wire cover to be mounted on a rear side in a connecting direction of a connector to be connected to a mating connector, wherein:
the connector includes a plurality of terminals disposed apart from each other in a first orthogonal direction orthogonal to the connecting direction and a plurality of wires connected to the respective terminals and pulled out from the rear side in the connecting direction,
the wire cover includes:
a housing having an insertion opening, the plurality of wires being inserted through the insertion opening, and a draw-out opening, the plurality of wires inserted through the insertion opening being drawn out through the draw-out opening in a direction intersecting the connecting direction; and
an assisting member for assisting three-dimensional bending of the respective wires inside the housing, and
the respective wires are three-dimensionally bent and drawn out through the draw-out opening by being bent in an intersecting direction intersecting the connecting direction by being assisted by the assisting member and further bent in a direction intersecting a plane specified by the connecting direction and the intersecting direction inside the housing.

2. The wire cover of claim 1, wherein:
the housing includes:
a first cover disposed on one side in a second orthogonal direction orthogonal to both the connecting direction and the first orthogonal direction with respect to the plurality of wires; and
a second cover facing the first cover across the plurality of wires,
the assisting member is a plate-like member to be disposed between the second cover and the wires, and
the respective wires extending rearward in the connecting direction by being inserted through the insertion opening are bent toward the second cover by being assisted by the assisting member at a position where the wires pass through the assisting member, and the respective wires bent toward the second cover are bent toward the draw-out opening by being assisted by the assisting member.

3. The wire cover of claim 2, wherein an edge part on a rear side in the connecting direction of the assisting member is inclined toward the rear side in the connecting direction from one side toward the other side in the first orthogonal direction.

4. The wire cover of claim 3, wherein:
one or a plurality of recesses are formed in the edge part of the assisting member, and
the respective wires bent toward the second cover by being assisted by the assisting member at the position where the wires pass through the assisting member pass through the recess(es).

5. The wire cover of claim 4, wherein the recess is formed for each wire.

6. The wire cover of claim 4, wherein the recess has a triangular shape when viewed from the second orthogonal direction.

7. The wire cover of claim 1, wherein the assisting member is coupled to the housing by a hinge.

8. The wire cover of claim 1, comprising a restricting portion disposed on the rear side in the connecting direction with respect to the assisting member, the restricting portion restricting movements of the wires in the housing in cooperation with the assisting member.

9. A connector structure, comprising:
a connector to be connected to a mating connector, the connector including a plurality of terminals disposed apart from each other in a first orthogonal direction orthogonal to a connecting direction and a plurality of wires connected to the respective terminals and pulled out from a rear side in the connecting direction; and
the wire cover of claim 1 to be mounted on the rear side in the connecting direction of the connector.
